(19) United States
(12) Patent Application Publication
(10) Pub. No.: US 2013/0342155 A1
(43) Pub. Date: Dec. 26, 2013

(54) ELECTRICITY GENERATION SYSTEMS AND METHODS

(71) Applicants: Dustin Dee Neel, Albuquerque, NM (US); Kevin Mark Bassalleck, Albuquerque, NM (US)

(72) Inventors: Dustin Dee Neel, Albuquerque, NM (US); Kevin Mark Bassalleck, Albuquerque, NM (US)

(21) Appl. No.: 13/918,588

(22) Filed: Jun. 14, 2013

Related U.S. Application Data
(60) Provisional application No. 61/663,111, filed on Jun. 22, 2012.

(51) Int. Cl. H01L 31/042; H01L 31/18

(52) U.S. Cl. CPC H01L 31/0422; H01L 31/18
USPC 320/101; 136/251; 29/890.033

(57) ABSTRACT

A modular assembly comprises a frame formed of a network of elongate members, a deployment skid, an electricity generation skid, at least one foldable door hinged to the frame, and at least one racking assembly attached to the frame. The frame defines a plurality of modular bays including a deployment bay, an electricity generation bay, and at least one energy storage bay. The deployment skid interfaces with the deployment bay, and the solar generation skid interfaces with the solar generation bay. In exemplary embodiments, the electricity generation bay is a solar generation bay and the electricity generation skid is a solar generation skid, at least one photovoltaic module is attached to the racking assembly, and a control unit may be operably connected to the photovoltaic module.

### CROSS-REFERENCE TO RELATED APPLICATION

This application is a non-provisional of and claims priority to U.S. Application Ser. No. 61/663,111, filed Jun. 22, 2012, which is hereby incorporated by reference in its entirety.

### FIELD

The present disclosure relates to modular assemblies including electricity generation systems.

### BACKGROUND

Reliable electricity supply in remote regions, particularly in the developing world, is an immediate problem. Lack of consistent or reliable electricity in these regions prevents access to basic needs, including, for example, lighting, charging and powering of household electronics and communications equipment, water pumping and sanitization, and refrigeration. Typically these needs are either neglected or accommodated through the use of fossil fuel generators.

These generators often require significant maintenance, and access to fuel can be logistically challenging, prohibitively expensive or unreliable. Additionally, generators can emit large amounts of noise and air pollution. Any functionality that requires electricity would also need a separate appliance compatible with the power supply and electrical characteristics of the generator, such as voltage, amperage, and suitable enclosures for remote applications, military use, and disaster relief or humanitarian efforts.

Solar generators have been used in these situations. However, typical solar powered generators are small units that provide a very limited amount of energy. In addition, they are typically comprised of individual and independent parts and components, which are not easily transported or assembled into a single, stand-alone generating unit. Moreover, common solar generators provide limited power, restricting their use to powering small household appliances such as cell phones, laptops, and tools. The systems are bulky for the small energy they provide, and typically have under-sized solar module relative to their energy storage capabilities. Many hours of solar access are needed for relatively small amounts of energy supply.

Accordingly, there is a need for an electricity generation system and method that provides larger amount of solar energy generating capabilities in a relatively small enclosure, which folds onto itself for easy transport and rapid deployment, easing logistics. There is also a need for electricity generation systems and methods that alleviate the need for separate wires, modules, racking systems, and the inverter, batteries and receptacles. A need exists for electricity generation systems and methods that provide a range of functions using interchangeable functional modules, which integrate into the base power enclosure and provide a range of solutions and capabilities to suit many different applications in the field.

### SUMMARY

The embodiments of the present disclosure alleviate to a great extent the disadvantages of known electricity generators by providing electricity generation assemblies, systems and methods wherein all the components are encased within the single unit, alleviating the need for separate wires, modules, racking systems, and the inverter, batteries and receptacles. Disclosed systems and methods also provide for a range of functions using interchangeable functional modules, which will integrate into the base power enclosure and will provide a range of solutions and capabilities to suit many different applications in the field. Exemplary units will provide clean, renewable, and reliable power in an elegant enclosure and provide for modular, interchangeable functional units.

Exemplary embodiments include a modular assembly comprising a frame formed of a network of elongate members, a deployment skid, an electricity generation skid, at least one foldable door hinged to the frame, and at least one racking assembly attached to the frame. The frame defines a plurality of modular bays including a deployment bay, an electricity generation bay, and at least one energy storage bay. The deployment skid interfaces with the deployment bay, and the solar generation skid interfaces with the solar generation bay. The deployment skid may include alignment features.

In exemplary embodiments, the electricity generation bay is a solar generation bay and the electricity generation skid is a solar generation skid, at least one photovoltaic module is attached to the racking assembly, and a control unit may be operably connected to the photovoltaic module. Exemplary embodiments may further comprise at least one stabilizer bracket connecting the at least one foldable door to the frame. The at least one stabilizer bracket may be connected to the at least one foldable door via one or more bracket pins. One or more racking posts may extend from the frame and connect the racking assembly to the frame. Exemplary embodiments may also include at least one north/south railing member and at least one east/west railing member. One or more batteries may be disposed in the energy storage bay.

Exemplary embodiments include methods of manufacturing a modular system comprising assembling a frame from a plurality of elongated members such that a resulting frame assembly defines a plurality of modular bays, inserting a skid into one or more of the modular bays, hingedly attaching at least one foldable door to the frame assembly, attaching one or more racking posts to a top portion of the frame assembly, and attaching a racking assembly to the one or more racking posts. The plurality of modular bays may include a deployment bay, a solar generation bay, and at least one energy storage bay.

Exemplary methods may further comprise connecting at least one stabilizer bracket to foldable door via bracket pins. Exemplary methods may further comprise attaching at least one photovoltaic module to the racking assembly. A deployment skid may be interfaced with the deployment bay, and a solar generation skid may be interfaced with the solar generation bay. Exemplary methods may further comprise disposing a control unit in the solar generation bay and operably connecting the control unit to the photovoltaic module. In exemplary methods, one or more batteries may be disposed in the energy storage bay.

Exemplary embodiments of a solar powered electricity generation system comprise a frame, at least one foldable door hinged to the frame, a deployment skid, a solar generation skid, and at least one racking assembly attached to the frame. The frame is formed of a network of elongate members and defines a plurality of modular bays including a deployment bay, a solar generation bay, and at least one energy storage bay. The deployment skid interfaces with the deployment bay, and the solar generation skid interfaces with the solar generation bay.

In exemplary embodiments, at least one photovoltaic module is mounted on the racking assembly. One or more batteries may be disposed in the energy storage bay, and the energy generated by the photovoltaic module may be stored in the one or more batteries. The system may further comprise a control unit in the solar generation skid and operably connected to the at least one photovoltaic module.

Accordingly, it is seen that electricity generation assemblies, systems and methods are provided in which all the components are encased within a single unit, the units are modular, interchangeable functional units, and they provide clean, renewable, and reliable power in an elegant enclosure. These and other features and advantages will be appreciated from review of the following detailed description, along with the accompanying figures in which like reference numbers refer to like parts throughout.

### BRIEF DESCRIPTION OF THE DRAWINGS

The foregoing and other objects of the disclosure will be apparent upon consideration of the following detailed description, taken in conjunction with the accompanying drawings, in which:

FIG. 1 is a front perspective view of an exemplary embodiment of an electricity generation system in accordance with the present disclosure;

FIG. 2 is a rear perspective view of an exemplary embodiment of an electricity generation system in accordance with the present disclosure;

FIG. 3 is a perspective view of an exemplary embodiment of a frame assembly of a modular assembly in accordance with the present disclosure;

FIG. 4 is a front view of an exemplary embodiment of a modular assembly in accordance with the present disclosure;

FIG. 5 is a side view of an exemplary embodiment of a modular assembly in accordance with the present disclosure;

FIG. 6 is a perspective view of an exemplary embodiment of a frame assembly of a modular assembly in accordance with the present disclosure;

FIG. 7A is a top perspective view of an exemplary embodiment of a deployment skid in accordance with the present disclosure;

FIG. 7B is a bottom perspective view of the deployment skid of FIG. 7A;

FIG. 7C is a front view of the deployment skid of FIG. 7A;

FIG. 7D is a side view of the deployment skid of FIG. 7A;

FIG. 8 is a perspective view of an exemplary embodiment of a modular assembly in accordance with the present disclosure;

FIG. 9 is a perspective view of an exemplary embodiment of a modular assembly in accordance with the present disclosure;

FIG. 10A is a top view of an exemplary embodiment of a stabilizer bracket in accordance with the present disclosure;

FIG. 10B is a side view of the stabilizer bracket of FIG. 10A;

FIG. 10C is a perspective view of an exemplary embodiment of a bracket pin in accordance with the present disclosure;

FIG. 10D is a perspective view of an exemplary embodiment of a stabilizer bracket and bracket pin in accordance with the present disclosure;

FIG. 10E is a perspective view of an exemplary embodiment of a stabilizer bracket and bracket pin in accordance with the present disclosure; and

FIG. 11 is an exemplary embodiment of a modular assembly and racking assembly in accordance with the present disclosure.

### DETAILED DESCRIPTION

In the following paragraphs, embodiments will be described in detail by way of example with reference to the accompanying drawings, which are not drawn to scale, and the illustrated components are not necessarily drawn proportionately to one another. Throughout this description, the embodiments and examples shown should be considered as exemplars, rather than as limitations of the present disclosure. As used herein, the “present disclosure” refers to any one of the embodiments described herein, and any equivalents. Furthermore, reference to various aspects of the disclosure throughout this document does not mean that all claimed embodiments or methods must include the referenced aspects.

In general terms, exemplary embodiments of modular assemblies for electricity generation and solar powered electricity generators are easily deployable to remote regions and capable of providing reliable and emission-free electricity supply and storage, with little maintenance requirements. Additionally, the housing of exemplary systems is designed to encompass and protect the critical components during transport. Exemplary systems and methods include a specialized compartment to accommodate a variety of functional modules, which can be designed specifically for the power system, and will serve a specific purpose using the electricity supplied by the generator. These may include, but are not limited to, lighting systems, additional energy storage, water pumping, water purification, de-humidifiers, refrigeration units, communications, equipment/tool charging and general electricity use. Exemplary systems and methods provide clean, predictable, low-maintenance solar power for remote applications while offering a base generator unit with interchangeable function modules.

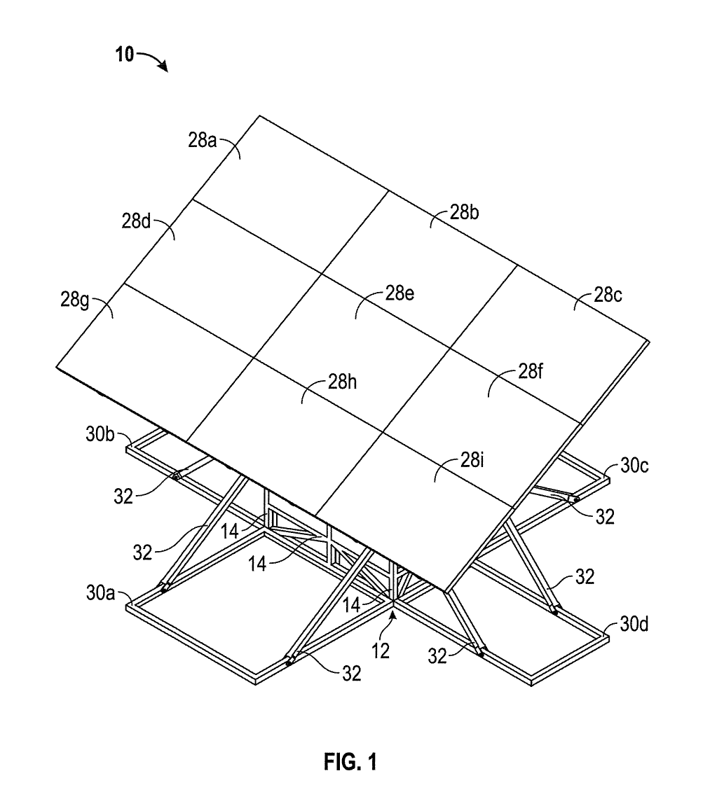

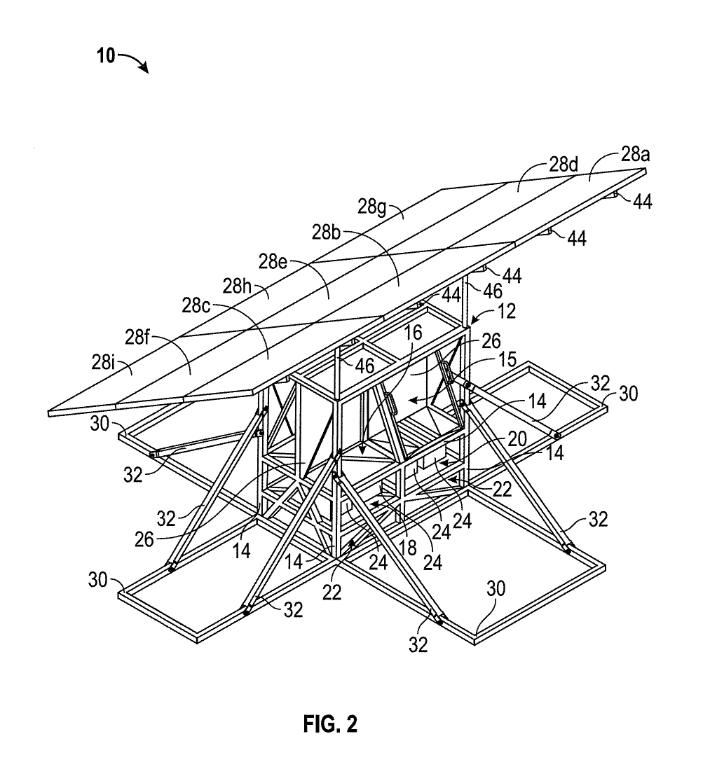

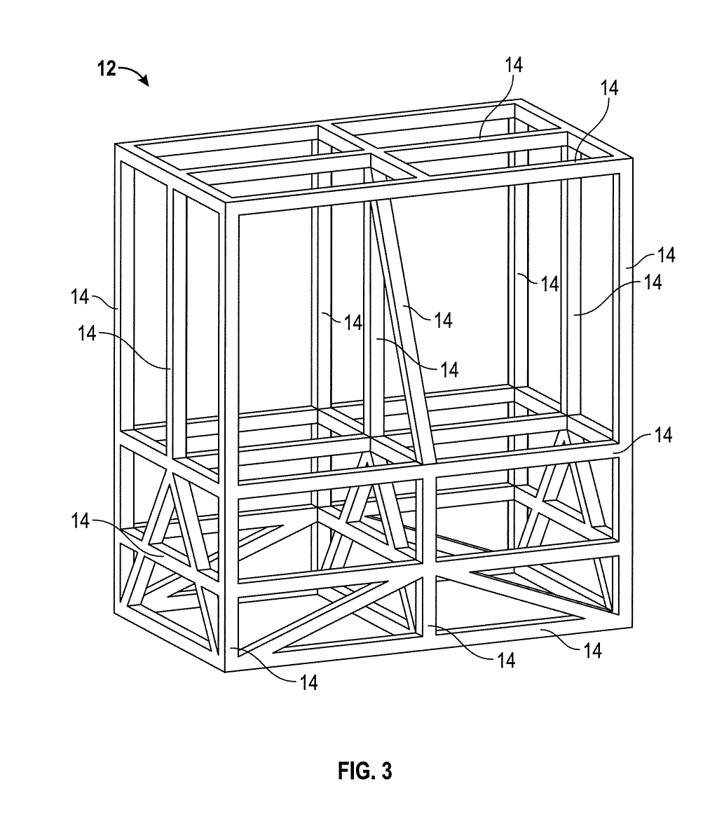

With reference to FIGS. 1 and 2, an exemplary embodiment of a modular assembly that can be used for electricity generation will be described. Modular assembly 10 comprises a structural cage or frame 12 formed of a network of elongate members 14. The elongate members 14 may be constructed of structural tube steel or the like, or any other material strong enough to house and support the components contained within the frame 12, as described herein. The frame 12, shown in more detail in FIG. 3, provides structural integrity and support and houses all the components for the modular assembly's function.

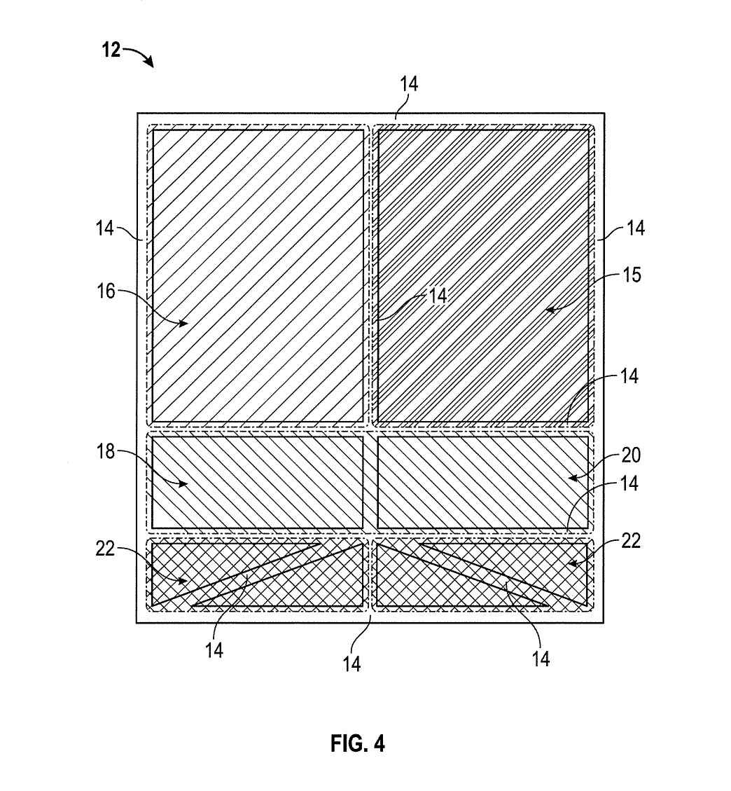

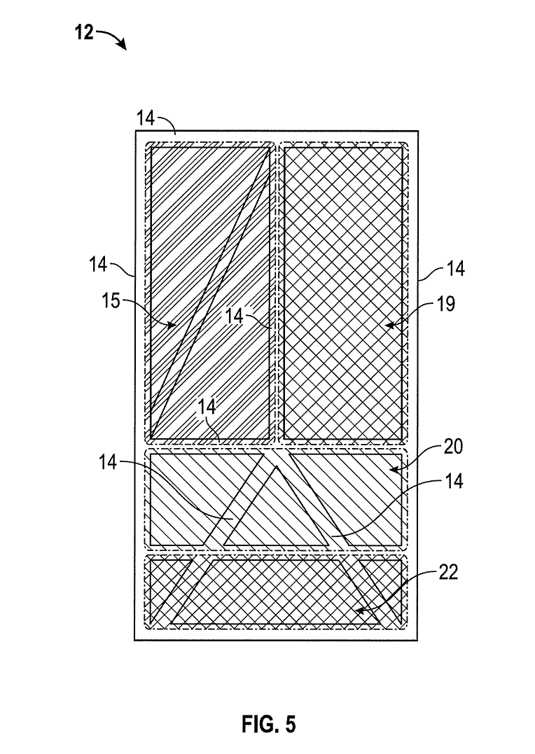

More particularly, frame 12 defines a plurality of modular bays 15, 16, 17, 18, 19, 20 to accept separate components, for specific intended field purposes. As shown in FIGS. 4 and 5, in exemplary embodiments the modular bays include a deployment bay 15, an electricity generation bay 16, and at least one energy storage bay 18. In an exemplary embodiment, there are two adjacent energy storage bays 18, 20 to house batteries or other energy storage devices 24. The electricity generation bay 16 may house energy generation equipment and associated electronics, gauges, displays, and like necessary for operation and converting energy into work functions or energy storage. The electricity storage bay 19 may be used to store and carry additional equipment including solar racking components.

The energy storage bays 18, 20 may house batteries 24 or like energy storage equipment. The batteries or other energy storage systems 24 can be sourced from common suppliers, utilizing lead-acid batteries, valve-regulated batteries, or lithium-ion batteries. Other energy storage technologies, including but not limited to fuel cells, could be substituted. Storage capabilities can be enhanced with advancements in technologies and added to energy storage bays 18, 20. One or more holding tank bays 22 provide for additional storage and holding space for custom uses, such as water tanks, extra batteries, or additional components or spare parts. An electricity generation skid 26 may be provided, which is a component skid that interfaces with the electricity generation bay 16.

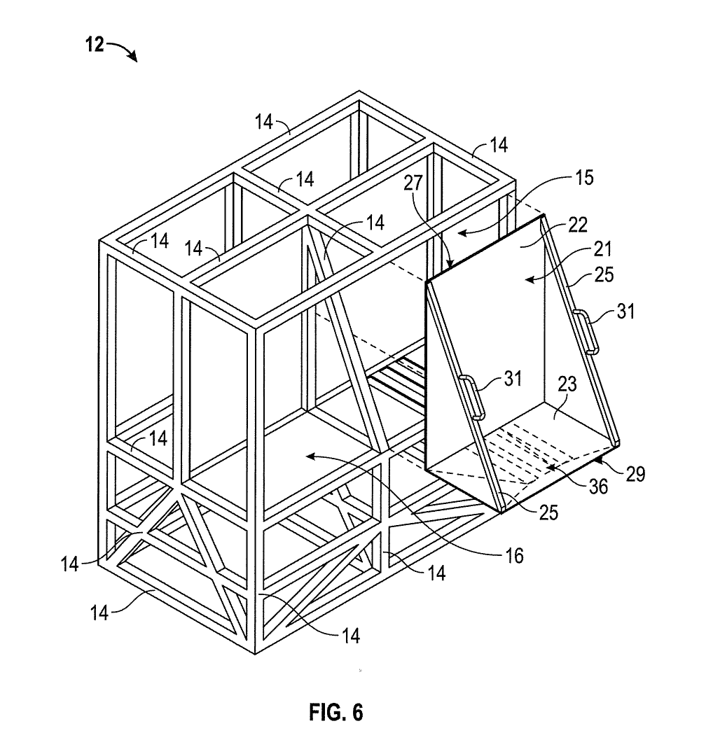

As shown in detail in FIG. 6, deployment skid 22 interfaces with deployment bay 15. More particularly, the deployment skid 22 is a customizable component skid that may be sized to fit within deployment bay 15. In exemplary embodiments, custom deployment bay 15 accepts the custom deployment skid 22 and provides the housing, control interface, and power connection between the custom deployment skid 22 and the modular assembly 10.

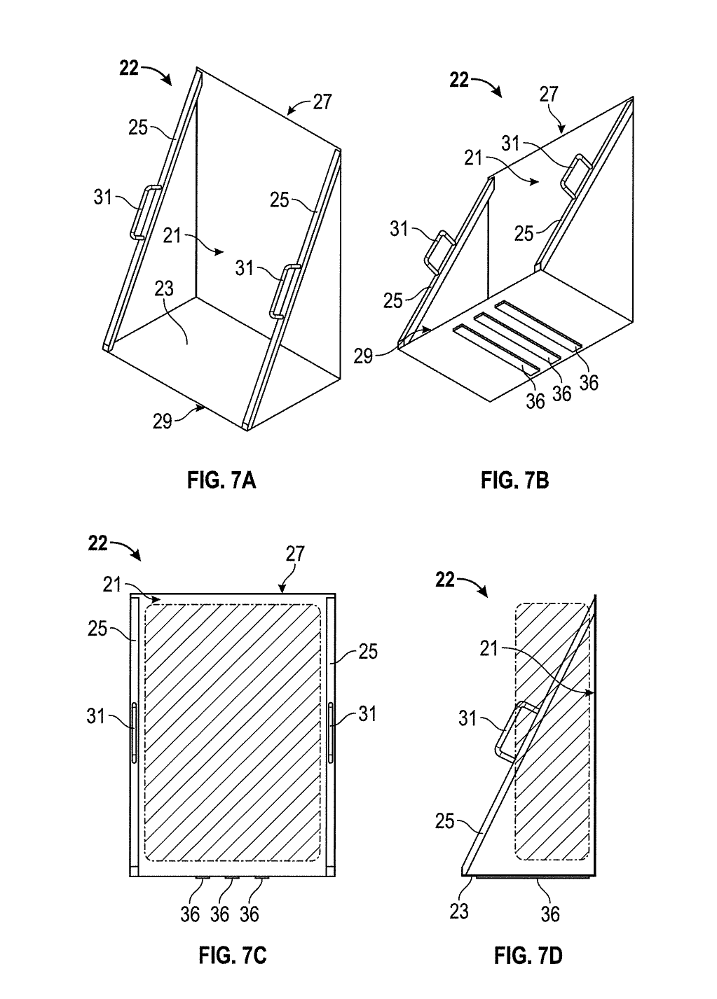

As best seen in FIGS. 7A-7D, exemplary embodiments of a deployment skid 22 may comprise a vertical plate 21 fixedly attached to a horizontal plate 23 in a perpendicular configuration, with an elongate skid frame member 25 at each side of the deployment skid. Each skid frame member 25 extends from a distal edge 27 of the vertical plate 21 to a distal edge 29 of the horizontal plate 23 and may have a grip handle 31 for ease of handling and insertion into the deployment bay 15. In exemplary embodiments, best seen in FIGS. 7B and 7C, the deployment skid 22 may include alignment features 36 such as guide rails to facilitate insertion into the deployment bay 15. As illustrated in FIG. 6, the guide rails 36 mate with guide members 38 in the deployment bay 15 so the deployment skid 22 may easily slide into the deployment bay 15 of the frame assembly 12. Advantageously, the functionality of the modular assembly 10 can be customized based on the nature and design of the custom deployment skid 22.

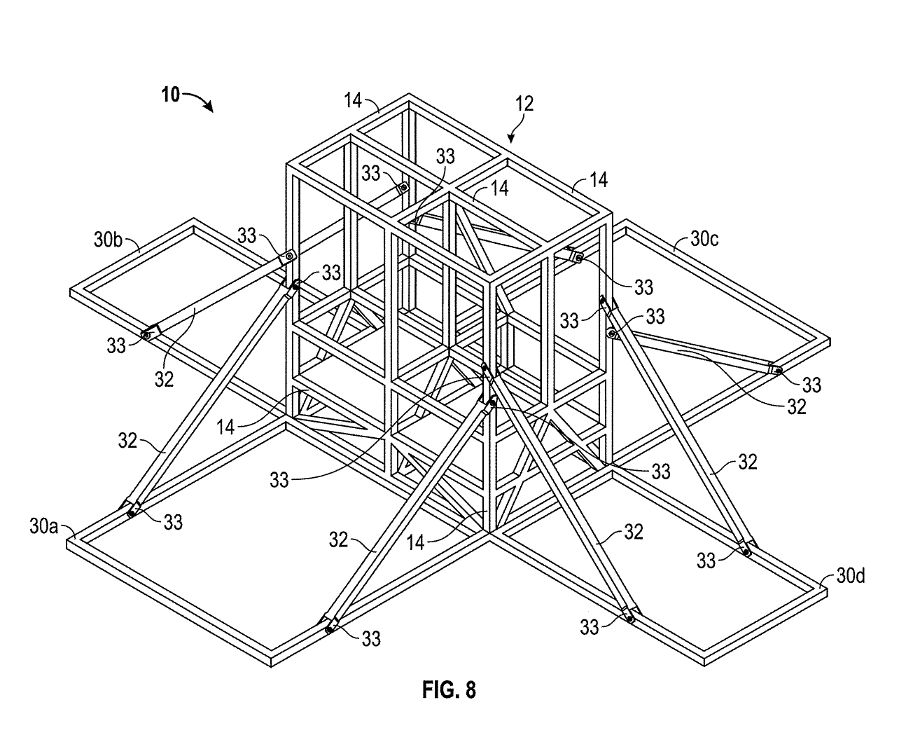

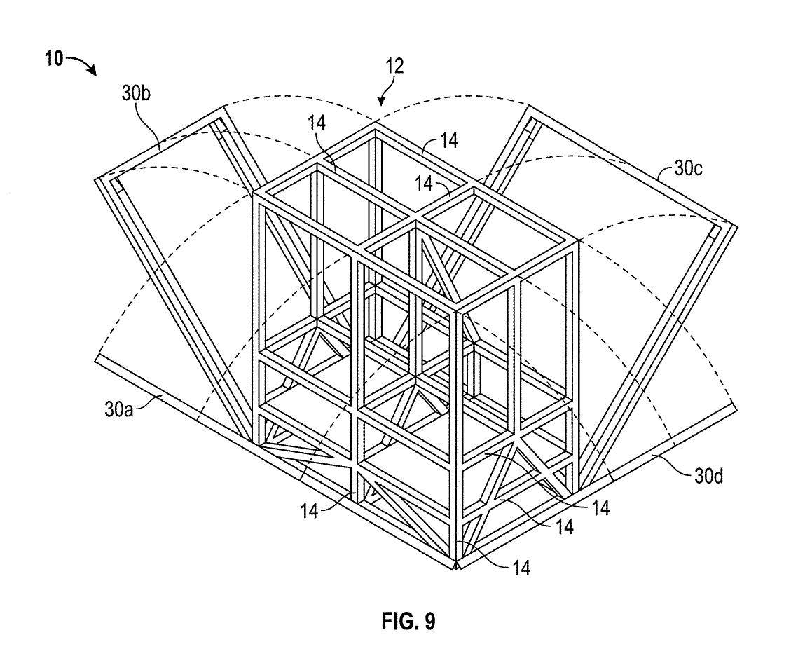

Turning to FIGS. 8 and 9, it can be seen that the modular assembly 10 may include one or more foldable stabilizer doors 30. In exemplary embodiments, four foldable doors 30a-30d are attached to the frame 12 near the bottom of the frame and are hinged to unfold away from frame 12. Advantageously, this hinged open door configuration provides foundational support and stability while the modular assembly is deployed. One or more stabilizer brackets 32 may fit inside the doors 30 when the doors in the folded configuration. The stabilizer brackets 32 may be removed from the doors or attached to both frame 12 and doors 30 using bracket pins 34 to secure the attachment points.

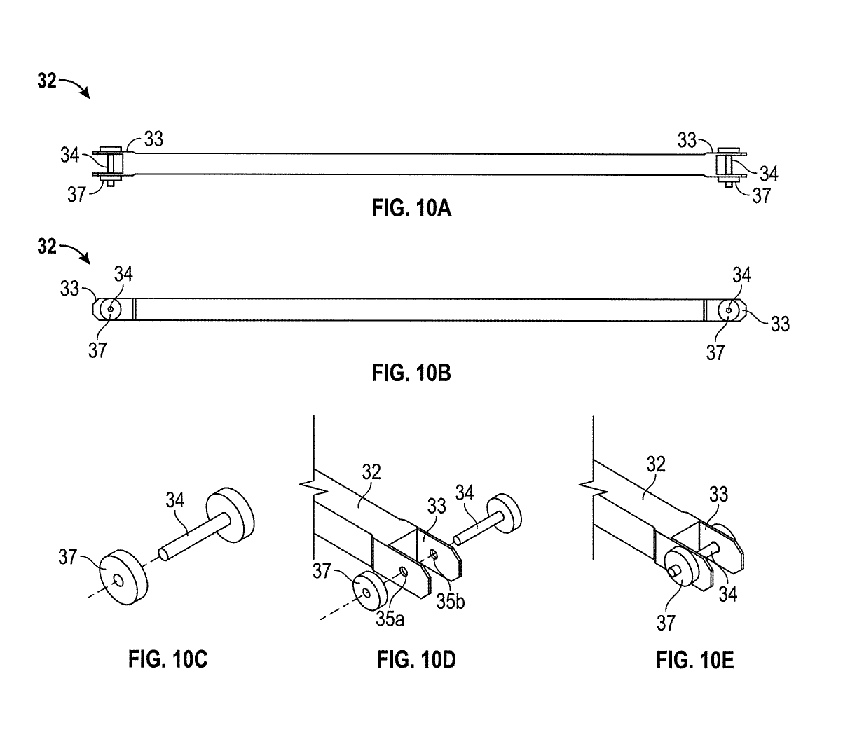

As best seen in FIGS. 10A-10E, exemplary stabilizer brackets 32 are elongate members having a bracket head 33 at each end. The bracket head 33 may be a welded, pre-drilled structure defining two apertures 35a, 35b therein. The apertures 35a, 35b receive the threaded bracket pin 34, which is secured to the bracket head 33 by a threaded nut 37, thereby fastening the stabilizer bracket 32 to a stabilizer door 30 at one end and to a modular frame assembly member 14 at another end. This secures each stabilizer door 30 to the frame assembly 12. The stabilizer brackets 32 may be made from metal, plastic, alloys, composites, or any other material capable of bracing and stabilizing the deployed doors 30 to the frame 12.

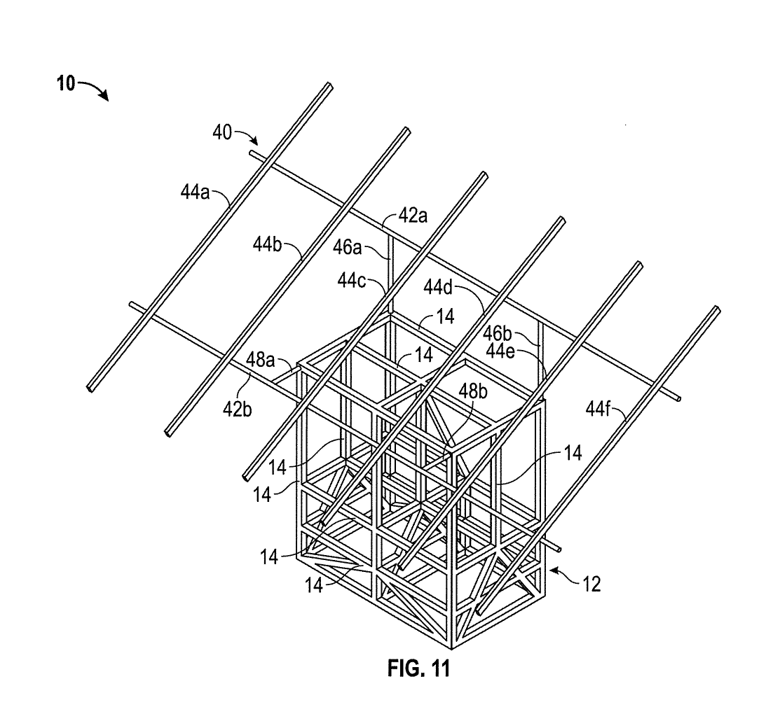

With reference to FIG. 11, exemplary embodiments further comprise a racking assembly 40. While multiple different components and configurations are possible, an exemplary embodiment includes at least one east/west railing member 42 and at least one north/south railing member 44. In exemplary embodiments, two east/west railing members 42a, 42b are arranged substantially parallel to each other and a plurality of north/south railing members 44a-44f are attached to the east/west railing members. The north/south railing members 44a-44f provide structural support for the racking assembly 40 and, as discussed in more detail below, can provide attachment points for PV modules.

As best seen in FIG. 11, racking posts 46, 48 may be provided to serve as structural support mechanisms and points of attachment for the racking assembly 40 to the frame assembly 12. More particularly, one or more vertical racking posts 46a, 46b may extend from a frame member 14 of the frame assembly 12 for attaching one of the east/west railing members 42a to the frame assembly 12 and provide vertical structural support for the racking assembly 40. One or more horizontal racking posts 48a, 48b may extend from a frame member 14 of the frame assembly 12 for attaching another east/west railing member 42b to the frame assembly 12 and provides lateral support for the racking assembly 12. It should be noted that different structural and attachment configurations are possible, and one or more of the north/south railing members 44a-44f could be attached to the frame assembly 12 and supported by one or both of the horizontal and vertical racking posts 46, 48.

In exemplary embodiments, the modular assembly is a solar powered electricity generation system 10, and the electricity generation bay is a solar generation bay 16. The solar generation bay 16 could house all solar photovoltaic (PV) generation equipment as well as the electronics, gauges, displays, and like necessary for operating the modular assembly 10 and converting solar PV energy into work functions or stored energy. Solar generation skid 26 is a component skid that interfaces with the solar generation bay 16. In exemplary embodiments employing solar power, the holding tank bays 22 may provide a storage area for PV modules 28 and certain racking/support elements while the modular assembly 10 is closed and in transit or stored mode. As best seen in FIGS. 1 and 2, at least one PV module 28 may be attached to the racking assembly 40. More particularly, in exemplary embodiments a plurality of PV modules 28a-28i are attached to north/south railing members 44a-44f, which are attached to the east/west railing members 42a, 42b, as discussed above. The PV modules 28 could be sourced through commercial partnership or purchasing from market suppliers.

Once activated, the PV modules 28 may begin collecting and converting solar energy into usable electricity. This may provide power for the electricity generating system's 10 operational function, as dictated by the custom deployment skid 22 to serve the modular assembly's intended purpose. Excess energy may be stored for later use during inclement weather or night operation by charging batteries 24 or like storage devices. In exemplary embodiments, stored energy may be routed back to the PV generation equipment in the PV generation skid 26 to power devices in the custom deployment skid 22, as needed.

In operation, manufacture or assembly of an exemplary modular assembly 10 is accomplished by first fabricating the frame assembly 12 from a plurality of elongated frame members 14. The frame members 14 could be any size or material depending on the needs, and exemplary embodiments may use 1-2″ tubular steel, or the like. The frame assembly 12 is constructed such that it defines a plurality of modular bays 14, 16, 18, 20 to accept separate components. As discussed above, in exemplary embodiments the modular bays include a deployment bay 15, an electricity generation bay 16, and at least one energy storage bay 18.

Next, one or more skids may be assembled and inserted into the bays 14, 16, 18, 20. In exemplary embodiments, a vertical plate 21 would be fixedly attached to a horizontal plate 23 in a perpendicular configuration, with an elongate skid frame member 25 at each side of the deployment skid 22. Each skid frame member 25 is attached so it extends from a distal edge 27 of the vertical plate 21 to a distal edge 29 of the horizontal plate 23, and a grip handle 31 may be attached to one or both of skid frame members 25. Assembly of the electricity generation skid 26 could be accomplished with commonly available electrical components from outside vendors, such as power inverters, wiring, charge controllers, switches, battery charge level indicators, and housings.

The skids 22, 26 may then be inserted into the corresponding modular bays. More particularly, electricity generation skid 26 would be inserted into electricity generation bay 16, and deployment skid 22 would be inserted into deployment bay 15. The deployment skid 22 could be easily slid into the deployment bay 15 by aligning and mating the guide rails 36 mate with guide members 38 in the deployment bay 15.

Foldable doors 30a-30d may be hingedly attached to the frame 12 near the bottom of the frame assembly 12 such that they unfold away from the frame. More particularly, the doors 30a-30d may be attached to the frame assembly 12 using stabilizer brackets 32. Bracket pins 34 may be used to secure the points where the stabilizer brackets 32 are attached to the door frame 39. The user assembling the modular assembly 10 would drill a hole in the door frame 39 and the frame member of the frame assembly 12 at the appropriate attachment point.

As best seen in FIGS. 10C-10E, the threaded bracket pin 34 would then be inserted through the appropriate hole and through apertures 35a, 35b defined in the bracket head 33. The threaded bracket pin 34 is then secured to the bracket head 33 by threaded nut 37 or any other suitable fastener, thereby fastening the stabilizer bracket 32 to a stabilizer door 30 at one end and to a modular frame assembly member 14 at another end. When deployed, the stabilizer doors 30a-30d and brackets 32 joined with bracket pins 34 provide for additional structural support and a foundation for the deployed unit as a whole.

The user may then assemble the racking assembly 40 and attach it to the frame assembly 12. As discussed above, an exemplary racking assembly 40 includes mounting or racking posts 46, 48 and railing members 42, 44. These components can be fabricated by common tubular or cylindrical steel, or any other materials strong enough to support the necessary components such as PV modules. The various racking support posts 46, 48 and railing members 42, 44 may be housed in the modular assembly 10 during transit, for example, in the holding tank bays 22, and may subsequently be removed from the holding tank bays 22, assembled and attached to the frame assembly 12 and to one another. More particularly, two east/west railing members 42a, 42b may be arranged substantially parallel to each other and a plurality of north/south railing members 44a-44f attached to the east/west railing members.

The racking assembly 40 may be attached to the frame assembly 12 by extending vertical racking posts 46a, 46b from a frame member 14 of the frame assembly 12 and attaching one of the east/west railing members 42a to the frame assembly 12. In addition, one or more horizontal racking posts 48a, 48b may be attached so they extend from a frame member 14 of the frame assembly 12 and serve as attachment points for another east/west railing member 42b to the frame assembly 12. Thus, when deployed, horizontal racking posts 48a, 48b and vertical racking posts 46a, 46b are extended or attached to the frame assembly 12 and provide support for east/west railing members 42a, 42b. In exemplary embodiments, PV modules 28 may be attached to the north/south railing members 44a-44f of the racking assembly 40. More particularly, the north/south railing members 44a-44f will attach to east/west railing members 42a, 42b and provide structural support and attachment points for the PV modules 28. The PV modules 28 are then attached to the appropriate controls on the PV generation skid 26, which may be activated to turn the solar powered electricity generation system 10 on.

Advantageously, exemplary solar powered electricity generation systems 10 can be scaled up or down in size, resulting in greater or lesser numbers of PV modules 28 and PV capacity, as well as battery storage capabilities, and/or inverter functionality. Development of a line of custom deployment skids could tailor the modular assembly 10 to a specific task or function, while the base unit provides power and energy storage for any of the compatible deployment skids to suit different tasks or functions at one site. Storage bays could incorporate additional functional skids, such as additional storage devices, additional deployment/functional skids, or spare parts. Once deployed, the electricity generation system 10 provides reliable, remote, clean energy and storage capabilities. The custom deployment skid can be tailored to suit a wide variety of roles and functions, based on market needs.

Thus, it is seen that modular assemblies and electricity generation systems, methods and processes are provided. It should be understood that any of the foregoing configurations and specialized components may be interchangeably used with any of the apparatus or systems of the preceding embodiments. Although illustrative embodiments are described hereinabove, it will be evident to one skilled in the art that various changes and modifications may be made therein without departing from the scope of the disclosure. It is intended in the appended claims to cover all such changes and modifications that fall within the true spirit and scope of the disclosure.

What is claimed is:

1. A modular assembly comprising:
a frame formed of a network of elongate members and defining a plurality of modular bays including a deployment bay, an electricity generation bay, and at least one energy storage bay;
a deployment skid interfacing with the deployment bay;
an electricity generation skid interfacing with the electricity generation bay;
at least one foldable door hinged to the frame; and
at least one racking assembly attached to the frame.

2. The assembly of claim 1 wherein the electricity generation bay is a solar generation bay and the electricity generation skid is a solar generation skid and further comprising:
at least one photovoltaic module attached to the racking assembly.

3. The assembly of claim 1 further comprising at least one stabilizer bracket connecting the at least one foldable door to the frame.

4. The assembly of claim 3 further comprising one or more bracket pins, wherein the at least one stabilizer bracket is connected to the at least one foldable door via the bracket pins.

5. The assembly of claim 1 further comprising one or more racking posts extending from the frame and connecting the racking assembly to the frame.

6. The assembly of claim 1 wherein the racking assembly includes at least one north/south railing member and at least one east/west railing member.

7. The assembly of claim 1 further comprising one or more batteries disposed in the energy storage bay.

8. The assembly of claim 1 wherein the deployment skid includes alignment features.

9. The assembly of claim 1 further comprising a control unit operably connected to the at least one photovoltaic module.

10. A method of manufacturing a modular system, comprising:
assembling a frame from a plurality of elongated members such that a resulting frame assembly defines a plurality of modular bays;
inserting a skid into one or more of the modular bays;
hingedly attaching at least one foldable door to the frame assembly;
attaching one or more racking posts to a top portion of the frame assembly; and
attaching a racking assembly to the one or more racking posts.

11. The method of claim 10 further comprising connecting at least one stabilizer bracket to the at least one foldable door via bracket pins.

12. The method of claim 10 further comprising attaching at least one photovoltaic module to the racking assembly.

13. The method of claim 10 wherein the plurality of modular bays includes a deployment bay, a solar generation bay, and at least one energy storage bay.

14. The method of claim 13 further comprising interfacing a deployment skid with the deployment bay and interfacing a solar generation skid with the solar generation bay.

15. The method of claim 14 further comprising disposing a control unit in the solar generation bay and operably connecting the control unit to the at least one photovoltaic module.

16. The method of claim 13 further comprising disposing one or more batteries in the energy storage bay.

17. A solar powered electricity generation system, comprising:
a frame formed of a network of elongate members and defining a plurality of modular bays including a deployment bay, a solar generation bay, and at least one energy storage bay;
at least one foldable door hinged to the frame;
a deployment skid interfacing with the deployment bay;
a solar generation skid interfacing with the solar generation bay;
at least one racking assembly attached to the frame; and
at least one photovoltaic module mounted on the racking assembly.

18. The system of claim 17 further comprising one or more batteries disposed in the energy storage bay.

19. The system of claim 18 wherein energy generated by the at least one photovoltaic module is stored in the one or more batteries.

20. The system of claim 17 further comprising a control unit in the solar generation skid and operably connected to the at least one photovoltaic module.
